(19) United States
(12) Patent Application Publication
(10) Pub. No.: US 2004/0133788 A1
(43) Pub. Date: Jul. 8, 2004

(54) Multi-precision exponentiation method and apparatus

(76) Inventors: Gregory M. Perkins, Pennington, NJ (US); Natsume Matsuzaki, Osaka (JP); Takatoshi Ono, Aichi-ken (JP)

Correspondence Address: RATNERPRESTIA, P O BOX 980, VALLEY FORGE, PA, 19482-0980, US

(21) Appl. No.: 10/337,501

(22) Filed: Jan. 7, 2003

(51) Int. Cl. H04L 9/32

(52) U.S. Cl. 713/189

(57) ABSTRACT

A multi-precision exponentiation method and apparatus for use in an encryption/decryption system is disclosed. The encryption/decryption operation uses a computer architecture that includes a central processing unit and a co-processor. The exponent may be represented by a binary data string. The method includes generating an initial look-up table that is indexed by a set of predetermined values. Each predetermined value represents the base raised to a respectively different exponential power. The co-processor calculates the base value raised to the exponent according to a predetermined exponential algorithm. The calculation includes retrieving a sequence of the predetermined values from the look-up table, each of the predetermined values corresponding to one of a plurality of sub-strings of the exponent data string. The method also includes generating, using the central processing unit, additional predetermined values in the look-up table concurrently with the co-processor calculating the base value raised to the exponent.

### FIELD OF THE INVENTION

The present invention relates generally to computer implemented exponentiation methods, and more particularly, to a faster and more efficient exponentiation method for multi-precision numbers.

### BACKGROUND OF THE INVENTION

The encryption of data for communication and storage utilizing a computer system is well known in the art. The encryption of data is accomplished by applying a cipher to the data to be encrypted. The cipher can be known only to the encrypter and the recipient (a “symmetric encryption” scheme) or can be a combination of the widely known cipher coupled with a securely held cipher (a “public key” scheme).

Some of the more popular methods, because of the relative invulnerability to breaking, are “public key” systems of cryptography. These methods utilize complex mathematical formulas employing large exponents (i.e., exponents of several hundred bits or more) because the inverse of exponentiation—the discrete logarithm—is a much more difficult operation than exponentiation.

Extremely large exponential values, however, extract a cost to the user in terms of the number of multiplications required and/or the amount of computer memory that is used to perform the operations. These types of multiplication operations are costly because the values to be multiplied exceed the bit-length of the processor and thus, are implemented as multi-precision operations.

A number a raised to an exponent e can always be calculated by multiplying that number by itself the number of times represented by the exponent, or in mathematical terms:

a^{e}=a*a*a . . . e number of times.

Another method, which is significantly faster, is the multiply chain algorithm. In this case, let e=eₙ₋₁eₙ₋₂ . . . e₁e₀ be an n-bit exponent eᵢ ∈ {0,1}, 0≦i≦n−1 and eₙ₋₁=1. The algorithm starts with p₁=a, then

pᵢ₊₁=pᵢ² if eₙ₋₁₋ᵢ=0 or a*pᵢ² if eₙ₋₁₋ᵢ=1, where 1≦i≦n−2.

Several methods are known in the art to reduce either the number of multiplications or the amount of computer memory needed to produce efficient exponentiation of the base value.

One method known in the art for reducing the number of multiplications is the “k-ary window method.” In this method, the exponent is again represented as a string of zero and one bits. Substrings of a predetermined fixed length (e.g., k bits) are extracted and examined against a reference look-up table, which contains the base value raised to specific powers (e.g., from 0 to 2^{k}). The substring under examination is used as a reference value to look-up the value of the base raised to the power represented by the numerical value of the bit string, and the intermediate value is stored, with a reference to the position of the least significant bit in the bit string that corresponds to the pattern. After traversal of the exponent bit string, the intermediate values are then multiplied together using a multiply chain algorithm to determine the base value raised to the original exponent value.

For example, if k=3 then the first k-bit sized window value would be the value from the look-up table that corresponds to the first three bits of the exponent. Further, the second k-bit window value would be the value from the look-up table corresponding to the second three bits of the exponent. The algorithm utilized in the k-ary window method computes a^{e} mod p by first performing k squarings and then multiplying the results of the k squarings by the look-up table value. Therefore, the k-ary window method computes a maximum of log₂(e)/k multiplications with a table pre-computation cost of 2^{k}−2. The k-ary window method reduces the number of required multiplications by

w(e)−(log₂(e)/k+(2^{k}−2)−K(e))

where w(e) is the weight of the exponent, and K(e) is the number of times that the k-bit window is zero.

A modification of the k-ary window method is to slide the window across the bits of the exponent e until the largest odd window value has been found. By using the sliding k-ary window method the size of the look-up table, that only includes odd exponents, may be cut in half while attaining the same expected weight value as the k-ary window method. Alternatively, a look-up table of the same size may contain exponents that are twice as large as for a conventional k-ary window algorithm.

As described above, computer based means of encryption and decryption communication utilizing exponentiation are well known in the art. However, most advanced encryption and decryption methods are too time consuming or memory intensive, or both, for use on small devices with limited computer usage cycles or memory. As such, there is a need for a more efficient exponentiation method in terms of both the computer cycles used and the amount of memory that is consumed.

### SUMMARY OF THE INVENTION

The present invention is embodied in a multi-precision exponentiation method and apparatus.

The subject invention is embodied in a encryption/decryption system that includes a method for raising a base value to an exponent. The encryption/decryption operation uses a computer architecture that includes a central processing unit (CPU) and a co-processor independent of the central processing unit. The exponent that the base value is raised to may be represented by a data string, for example, a binary string of ones and zeros.

The method includes a step of generating an initial look-up table that is indexed by a set of predetermined values. Each member of the set of predetermined values represents the base raised to a respectively different exponential power. This initial look-up table may be stored in the main memory of the computer system. The method also includes a step of calculating, in the co-processor, the base value raised to the exponent. The co-processor calculates the base value raised to the exponent according to a predetermined exponential algorithm. The calculation of the base value raised to the exponent includes a step of retrieving a sequence of the predetermined values from the look-up table. Each of the predetermined values in the sequence retrieved corresponds to one of a plurality of sub-strings of the data string. The method also includes the step of generating, using the central processing unit, additional predetermined values in the look-up table concurrently with the step of calculating (the base value raised to the exponent) to increase the size of the look-up table while the exponentiation operation is in progress.

Through the various embodiments of the present invention herein described, at least three methods are included for combining the resources of the central processing unit and the co-processor to more efficiently perform the exponentiation calculation used in the encryption/decryption system. Each of the three exemplary methods may utilize a sliding window calculation method. A first exemplary method includes building and storing a look-up table. The look-up table is used by the central processing unit to retrieve and send values to the co-processor that are needed in the exponentiation calculation that is being performed by the co-processor. A second exemplary method includes building a look-up table, calculating the base value raised to the exponent using the co-processor, and expanding the look-up table using the central processing unit while the co-processor performs the exponentiation calculation. A third exemplary embodiment includes expanding the look-up table, using the central processing unit, to include a look-up table value that will be used by the co-processor during the exponentiation calculation. The look-up table value that will be used by the co-processor may be the very next look-up table value needed by the co-processor during the exponentiation calculation. In such an embodiment, the central processing unit can look ahead, and, based on the central processing unit/co-processor modmul ratio, determine which value needs to be added to the look-up table next.

Other features and advantages of the invention will be set forth in, or apparent from, the following detailed description of the preferred embodiment of the invention.

### BRIEF DESCRIPTION OF THE DRAWINGS

The foregoing summary as well as the following detailed description of the exemplary embodiments of the invention, will be better understood when read in conjunction with the appended drawings. For the purpose of illustrating the invention, there is shown in the drawings several exemplary embodiments of the invention. It should be understood, however, that the invention is not limited to the precise arrangements and instrumentalities shown. It is emphasized that, according to common practice, the various features of the drawings are not to scale. On the contrary, the dimensions of the various features are arbitrarily expanded or reduced for clarity. Included in the drawings are the following Figures:

FIG. 1 is a block diagram illustrating an exemplary embodiment of the hardware architecture suitable for use with present invention.

FIG. 2 is a block diagram which shows details suitable for use in the system shown in FIG. 1, including a co-processor with a limited RAM.

FIG. 3 is a flow chart diagram which is useful for describing an exemplary embodiment of the present invention.

FIG. 4 is a flow chart diagram which is useful for describing another exemplary embodiment of the present invention.

### DETAILED DESCRIPTION OF THE INVENTION

Computer systems utilized to perform exponentiation calculations may have an architecture that includes a co-processor in addition to a main microprocessor. This is because exponentiation involving large exponents is performed much faster in a co-processor (e.g., a math co-processor) than in a general purpose microprocessor used in a personal computer.

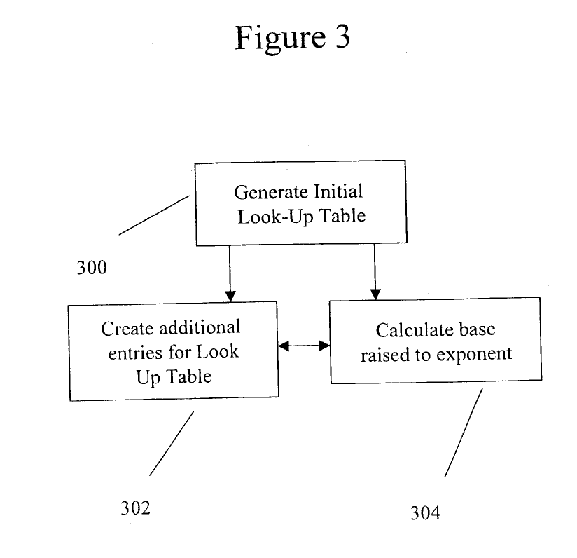

FIG. 3 is a flow chart that illustrates a method of calculating a base value raised to an exponent for use in an encryption/decryption operation. At step 300, an initial look-up table is generated. For example, a CPU of a computer system uses a co-processor, also included in the computer system, to generate the predetermined values to be stored in the look-up table in the main memory (RAM) of the computer system. Each of the predetermined values in the look-up table that is calculated by the co-processor corresponds to the base value raised to an exponential value. After the initial look-up table has been generated, steps 302 and 304 occur concurrently. At step 302, additional entries for the look-up table are created by the CPU. While the CPU is creating the additional entries for the look-up table, the co-processor is performing the exponentiation calculation at step 304. For example, the co-processor may be performing the exponentiation calculation in conjunction with the CPU according to sliding window method, or the k-ary window method described above. As the CPU stores the additional entries in the main memory at step 302, these additional entries may be used by the co-processor during the exponentiation calculation at step 304.

According to the exponential algorithm used in the calculation, an initial window size may be selected. The initial window size may correspond to the maximum value (bit size) in the initial look-up table. In controlling the exponentiation calculation, the CPU transfers a look-up table value corresponding to the first sub-string window value to the co-processor for calculation. While the co-processor commences the exponentiation calculation, the CPU calculates additional entries for inclusion in the look-up table. When the maximum value in the look-up table corresponds to a larger window size, the window size used by the CPU in the exponentiation calculation may increase accordingly. For example, assuming the table stores only odd exponent values, the initial window size k may be three, and the corresponding table may have four entries. In an exemplary embodiment of the present invention, after an additional entry is calculated by the CPU and stored in the look-up table, the window size k may be increased to (k+1). A check may be made to determine if the k+1 sized bit value is in the look-up table. If it is not the window size is temporarily reduced by 1 (i.e., k-sized). This process of increasing the window size during the exponentiation calculation may be continued until the base value raised to the exponent has been computed.

In such an embodiment, where the window size is increased as the look-up table increases in size, a check may be provided to determine if the look-up table is sized for the increased window size. For example, the check may determine if the window size (that has been increased) is larger than the largest value in the look-up table. Alternatively (or additionally), the check may determine if specific look-up table values corresponding to the increased window size have not yet been added to the table.

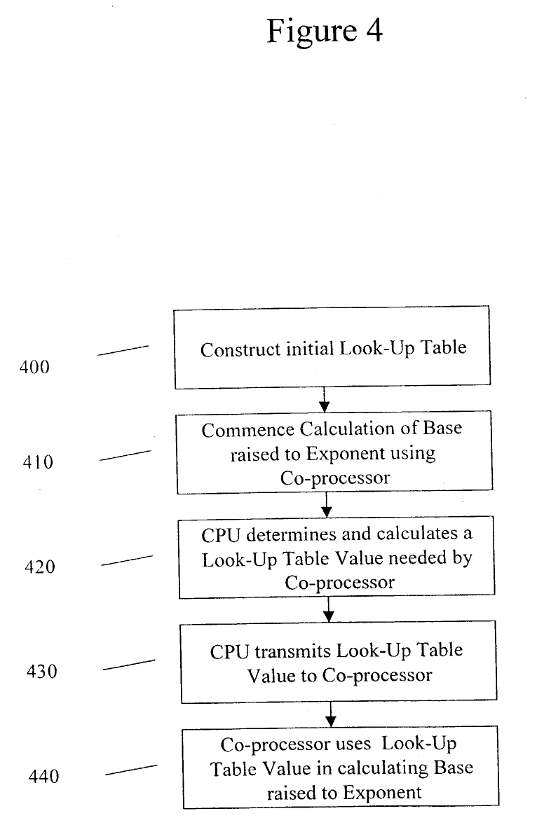

FIG. 4 is a flow chart that illustrates another exponentiation method for use in an encryption/decryption operation. At step 400 an initial look-up table is constructed. For example, the CPU can use the co-processor to generate the predetermined values of the initial look-up table, and the initial look-up table can be stored in the main memory (RAM) of the computer system. At step 410, the calculation of the base raised to the exponent is commenced using the co-processor. As with the method described by reference to FIG. 3, the co-processor may commence the calculation of the base raised to the exponent according to sliding window method, for example, or the k-ary window method. At step 420 the CPU determines and calculates a look-up table value that is needed by the co-processor in the calculation of the base value raised to the exponent. For example, the CPU may calculate the next look-up table value needed by the co-processor; however, the next look-up table value needed by the co-processor may already be in the look-up table, or there may not be time to compute the next look-up table value needed by the coprocessor. As such, at step 420, the CPU determines and calculates a look-up table value that will be needed at some time by the co-processor. At step 430, the CPU transmits the next look-up table value needed to the co-processor. Finally, at step 440, the co-processor uses the next look-up table value needed in calculating the base value raised to the exponent.

In the method described by reference to FIG. 4, the CPU divides the binary data string into k-sized window sub-strings. This does not mean that a 64 bit long string will be divided into 16 k-sized sub-strings when initially k=4 (i.e., the window size varies in the sliding window method). Rather, in an exemplary embodiment of the present invention, the CPU scans the bit string and returns the next odd value that is no larger than 2^{k-1}. The CPU retrieves a value from the look-up table that corresponds to each of the sub-strings, and transfers the retrieved value to the co-processor for calculation. Therefore, the CPU controls the retrieval of the respective look-up table values, and the subsequent transfer of these values to the co-processor. By looking ahead in the exponent, the CPU is able to determine the next look-up table value to be used by the co-processor. Accordingly, the CPU is able to calculate the next look-up table value used by the co-processor as described above at step 420.

Because the CPU is used to create additional look-up table values at the same time that the co-processor is performing the exponentiation calculation, the time required to perform the exponentiation calculation is reduced.

The present invention relates to exponentiation methods used in an encryption/decryption operation. The encryption/decryption operation utilizes a computer architecture that includes a CPU and a co-processor that is independent of the CPU. The exponentiation apparatus and methods presented are relevant to any exponentiation method that uses a look-up table. For example, the present invention is directly applicable to the sliding k-ary window method and the sliding NAF (non-adjacent form) k-ary window method. In the sliding NAF k-ary window method, which is useful in Elliptic Curve Cryptography, a sliding window is applied upon the non-adjacent form representation of the exponent e. In this method, each window value is odd, however, each window value may be positive or negative depending upon the most significant bit. Once the non-adjacent form of the exponent (and the corresponding table) has been constructed, this method is very similar to the sliding window method.

In preferred embodiments of the present invention the CPU has sufficient random access memory (RAM) to store a look-up table, while the co-processor may have more limited RAM. Further, it is typical for the co-processor to be able to compute multi-precision arithmetic faster than the CPU.

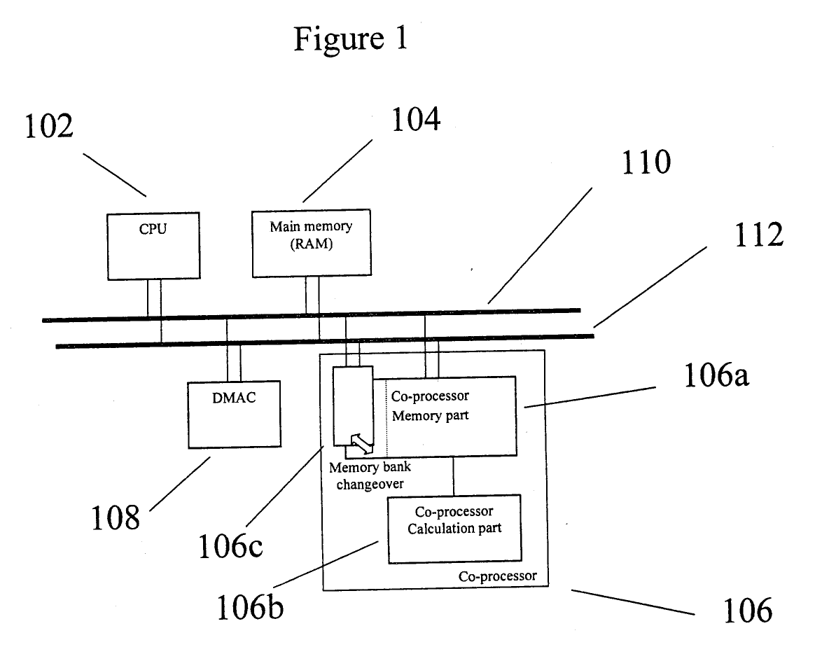

FIG. 1 is a block diagram that illustrates operation of an exemplary embodiment of the present invention. The computer architecture illustrated in FIG. 1 includes a number of components connected by a data bus 110 for carrying data, and an address bus 112 for carrying memory addresses where data items are to be found. The system includes CPU 102, main memory (RAM) 104, direct memory access controller (DMAC) 108, and co-processor 106. Co-processor 106 includes a memory part 106a and a calculation part 106b. The memory part 106a further includes a memory bank changeover 106c.

DMAC 108 is used to access memory without involving the CPU 102, and provides data transfer between the main memory 104 and the co-processor 106.

For example, the exponentiation calculation may be y^{x} mod p, where x and y are selected from the field Fₚ, where p is a prime number. Further, the exponentiation calculation typically involves large exponents, such that the log₂(p)>64. In preferred embodiments of the present invention the calculation method relates to 1024 or 2048 bit exponentiation. Because the CPU 102, DMAC 108, and the co-processor 106 can function in parallel, both the co-processor 106 and the CPU 102 can be used during the exponentiation computation.

Using the computer architecture system illustrated in FIG. 1, a look-up table is generated and stored in the main memory 104. The look-up table is indexed by a set of predetermined values, where each of the predetermined values represents the base value of the exponentiation calculation raised to one of a number of different exponential powers. For example, the predetermined values included in the look-up table may be generated using the co-processor 106 and transferred to main memory 104 using data bus 110 and address bus 112. After the initial look-up table is generated and stored in main memory 104, the co-processor 106 begins the exponentiation calculation. In performing the exponentiation calculation the co-processor 106 follows a predetermined exponential algorithm. In an exemplary calculation, the exponent is represented by a data string of ones and zeros and the data string is divided into a plurality of sub-strings. The plurality of sub-strings may be of a certain bit width, known as a bit-window size or a window size. For example, the data string may be broken into a plurality of sub-strings or windows that are three bits in length. In the sliding window method there may be sub-strings of zeros of arbitrary length that have no corresponding look-up table value, and represent a situation where the co-processor performs simple and repeated squarings.

Following the exponential algorithm, look-up table values corresponding to each of the plurality of sub-strings are successively retrieved and stored in memory using the co-processor memory part 106a and the memory bank change over 106c. As each of the predetermined values are retrieved and stored, the values are used by the co-processor calculation part 106b in performing the exponential calculation.

While the co-processor 106 is performing the exponentiation calculation, the CPU 102 generates additional predetermined values in the look-up table. For example, the additional predetermined values generated by the CPU 102 may correspond to the base value raised to increasingly large exponential powers. These additional predetermined values are then stored in main memory 104 for use by the co-processor 106 in completing the exponentiation calculation. Because the CPU 102 can add larger and larger predetermined values to the look-up table, the size of the sub-string of the data string (the window size) may accordingly increase, thereby further decreasing the time required by the co-processor 106 to perform the exponentiation calculation.

In an exemplary embodiment of the present invention, the window size will be continually resized to match the size (bit-length) of the largest look-up table value. For example, the largest initial look-up table value may correspond to a three bit sub-string. Accordingly, the initial window size may be three bits in length. When the largest look-up table value corresponds to a four bit sub-string, the window size used in the exponentiation calculation may be increased to 4 bits in length.

In embodiments where the window size is increased during the exponentiation operation, a check may determine if the returned sliding window value (that has been increased) is larger than the largest value in the look-up table, and/or the check may determine if specific look-up table values of the increased window size have not yet been added to the table.

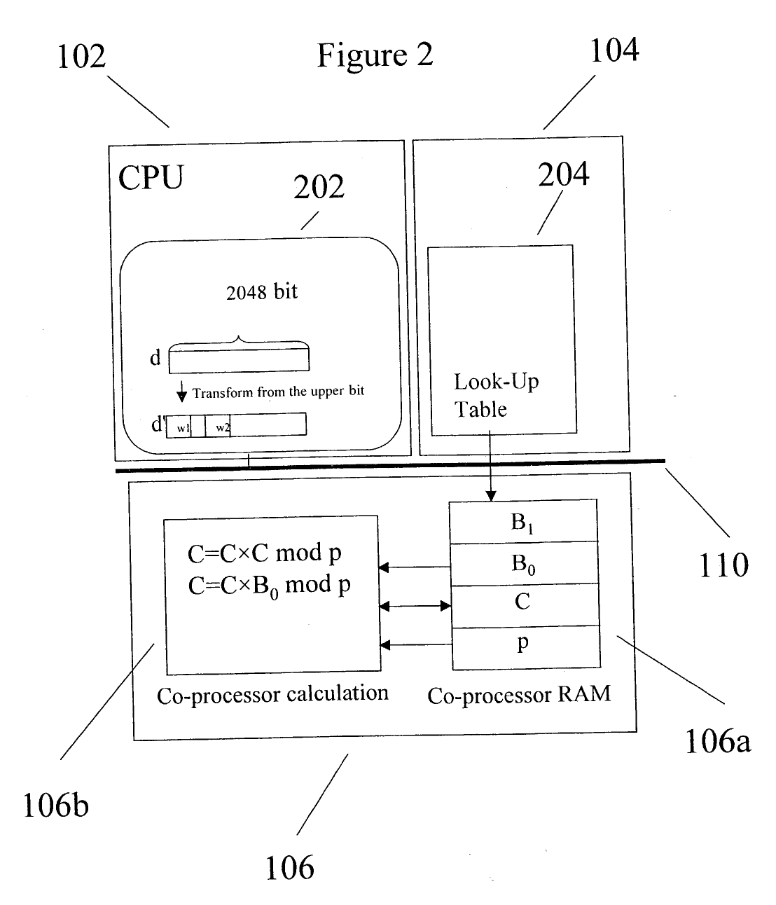

FIG. 2 illustrates the look-up table 204 that is preferably stored in the main memory RAM 104. The 2048 bit length string d is also stored in the main memory 104, however, the operation of converting the string d into a string d′ that includes a plurality of sub-strings occurs in the CPU 102. This conversion is represented by operation 202 in FIG. 2. The CPU 102 stores and converts a portion of the 2048 bit string d according to available memory. For example, the CPU 102 may store and convert 32, 64 or 128 bits of the bit string d at any given time. The CPU 102 and the main memory 104 are both connected to the DMAC bus 110 (the data bus). The co-processor 106 is also connected to the DMAC bus 110. The co-processor 106 includes the co-processor RAM 106a, and the co-processor calculation section 106b.

The CPU 102 operates on the 2048 bit string d, and identifies window values (e.g., w1, w2, etc.) to be used by the co-processor 106. The CPU 102 controls the actions of the multi-precision co-processor 106 and transfers values from the look-up table 204 to the co-processor RAM 106a via the DMAC bus 110. The co-processor RAM 106a, for example, may be 1.5 KB in size, which allows for the temporary storage of four 2048 bit multi-precision integers or ten 1024 bit multi-precision integers. This exemplary amount of co-processor RAM 106a would be sufficient for the exponential calculation because one of the values stored in the co-processor RAM 106a (B₀ or B₁) will be the next table value used during the modular multiplication, while the other value will be updated from the look-up table 204 via the DMAC bus 110. As such, values B₀ and B₁ may alternately be used as the next table value used during modular multiplication and the next value updated from the look-up table 204.

In one exemplary embodiment, the architecture illustrated in FIG. 2 is used in the sliding k-ary window exponentiation method. In such an embodiment, the CPU 102 controls the co-processor 106 and the DMAC 108(not shown in FIG. 2). In an embodiment where the exponentiation calculation is represented by the expression y^{x} mod p, the CPU 102 initializes the co-processor 106 for exponentiation by first transmitting y (e.g., stored in value B₀) and p (e.g., stored in B₄). During the exponentiation calculation the CPU 102 selects a desired table value from the look-up table 204 stored in the main memory RAM 104 to be transferred to the co-processor RAM 106a. Specifically, the CPU 102 retrieves the look-up table value that corresponds to each of the k-window sized sub-strings of the exponent data string. CPU 102 transfers the value from the look-up table 204 to the co-processor 106 for calculation according to the algorithm being used.

As indicated above, the main memory 104 coupled to the CPU 102 is used to store the table values in the look-up table 204. In an exemplary embodiment of the present invention, the CPU 102 calculates the values of the look-up table 204 by having the co-processor 106 compute y², for example, which is stored in B₁ while a value of y is stored in B₀. Next, the CPU 102 has the co-processor 106 compute y³=y*y². The calculated value y³ is then returned to the CPU 102 for storage, and is also stored in a value such as B₀. Then the co-processor 106 computes y⁵=y³*y², and sends the calculated value to the CPU 102 and further stores the value in B₀. This process is repeated until the last value for the initial look-up table 204 has been computed and stored.

During the exponentiation calculation, the DMAC 108 transports each value selected by the CPU 102 from the main memory 104 to the internal memory of the co-processor 106. Once the operation is started, the DMAC 108 transfers the data values from the main memory 104 to the co-processor memory 106a without further intervention from the CPU 102 or the DMAC 108. The selected look-up table value transported to the co-processor 106 is dependent upon the value of the next sliding window sub-string value identified by the CPU 102 according to the exponentiation algorithm used.

As described above, the co-processor 106 consists of a memory section 106a (RAM) and hardware for the multi-precision calculation (calculation part 106b). The co-processor 106 can compute a modular square and perform modular multiplication based upon the data values stored in its RAM 106a. At each step of the exponentiation calculation, the co-processor 106 receives a new look-up table value and a value j that defines the number of modular squarings to be calculated. For example, the value j may be sent to the co-processor 106 first. The co-processor 106 then computes the j modular squarings based upon the current exponentiation value C. The current exponentiation value C represents the result of the calculation at that point of the exponentiation operation, and is therefore only a partial value. The current exponentiation value C is stored in co-processor RAM 106a, as illustrated in FIG. 2. This modular squaring calculation occurs while the next look-up table value is being sent to the co-processor 106. After the j modular squarings have been computed, a single modular multiplication is computed using C and the newly transmitted look-up table value.

While the co-processor 106 is performing the exponentiation calculation, the CPU 102 is used to extend the look-up table 204 beyond the size of the initial look-up table 204 calculated by the co-processor 106. In order to perform the exponentiation calculation faster, the CPU 102 extends the look-up table 204 in an efficient manner. As such, a CPU/co-processor ratio exists, and represents the number of modular squarings that the co-processor 106 can perform while the CPU 102 is computing a singular modular multiplication. The ratio is typically greater then one, and defines how useful the CPU 102 can be during the extension of the look-up table 204. Typically, the lower the CPU/co-processor ratio, the smaller the initial look-up table size will be.

For example, after the construction of the look-up table 204, the CPU 102 begins the exponentiation calculation on the co-processor chip 106. While the co-processor 106 is commencing the exponentiation calculation according to a predetermined exponentiation algorithm, the CPU 102 begins the computation of the next look-up table value. For example, if the largest value in the initial look-up table is y, then the CPU 102 may compute y^{j+2}=y^{j}*y². This method is known as the table size plus two method. While computing this value, y^{j+2}, the CPU 102 will continue to transfer the next table value and the number j of modular squarings to the co processor chip 106 as necessary. Once y^{j+2} has been computed, the CPU 102 will add this value to the look-up table 204 and use it in the exponentiation calculation as needed. This process is repeated until the base value raised to the exponent has been calculated.

Depending upon the CPU 102 used, the CPU/co-processor ratio will vary. In order to optimize the initial look-up table size, the method of exponentiation can be simulated. A routine has been developed that can be used to determine the optimal initial look-up table size for a given CPU/co-processor ratio. By using the method described above, where the CPU 102 computes y^{j+2} when the largest initial look-up table value is y^{j}, the overall computation time can be reduced, particularly when the CPU/co-processor ratio is less than or equal to 60.

In an alternative embodiment, for example, that uses a sliding window method, the co-processor 106 calculates the base value raised to the exponent by dividing a data string that corresponds to the exponent into a plurality of substrings of length k. The CPU 102 sends values from look-up table 204 to the co-processor for use in the exponentiation calculation. The values sent by the CPU 102 are look-up table values that correspond to each of the substrings. Additionally, look-up table 204 may be built based upon a characteristic of the data string. For example, the data string may be of a certain length, or may include certain bit combinations, that only requires a look-up table 204 of a certain size, or a look-up table with a maximum window size of k. As such, before the exponentiation calculation is commenced, a look-up table 204 may have already been constructed that includes look-up table values corresponding to each of the substrings in the data string. As such, the initial look-up table 204 may be optimally constructed for the specific data string, or a characteristic of the data string (e.g., data string length or data string bit combinations).

Further still, based upon the size e of the data string, an optimal starting window size k and an optimal initial look-up table size may be determined (for example, using code). In various exemplary embodiments of the present invention (e.g., in methods that extend the sliding window), the initial ok-up table size may be smaller than 2^{k-1.}

In an alternative embodiment, the CPU 102 can compute the next useful table value (e.g., y^{x}) rather then the table size plus two value (y^{j+2}). An example of such a method is known as the table size plus one method, where the next useful table value is represented by the table size plus one. In another example the next useful table value may be represented by y^{x} where x is greater than or equal to j+2. After the next useful table value y^{x} is calculated, the CPU 102 stores this value in the look-up table 204.

For example, suppose the initial look-up table 204 is constructed with the largest value being y³¹. Rather then have the CPU 102 next compute y³³, the table size plus one value, y³² is computed. Then the routine looks ahead to see which window value in the range of [y³³, y⁶³] will next be needed. Suppose that the value y⁴⁷ is needed.

The CPU 102 may then next compute y³²*y¹⁵=y⁴⁷ in order to make immediate use of that look-up table value.

This method has the drawback of needing to compute values such as y³², y⁶⁴, and y¹²⁸ as needed, but may be more efficient for a number of reasons. First, an entire look-up table 204 covering the base value raised to the largest exponent may not be required. Additionally, by computing the next needed window value, immediate use of the CPU's computations are made, leading to fewer modular multiplications. For example, using the example shown above, it would be unlikely that all of the values between y³³ and y⁴⁵ could be computed before needing value y⁴⁷.

The inventor has determined that during 1024-bit exponentiation, the values between y³ and y³¹ are typically used. Further, in 2048-bit exponentiation, the inventor has determined that values between y³ and y⁶³ are typically used. Therefore, the CPU 102 can initially extend the look-up table 204 through y³¹ and y⁶³ respectively, depending on whether 1024 or 2048-bit exponentiation is used. Then y³² (or y⁶⁴ in 2048-bit exponentiation) is computed and all needed window values up to y⁶³ (or y¹²⁷) are computed as they are identified in the remaining bits of the exponents that still need to be processed. To do this, the routine simulates the exponentiation procedure in order to determine the next table value to compute. While this method may be more costly in time than the previously described method, it is still much less expensive in time than a single modular multiplication (O(n) vs. O(n²)). Once the next table range has been filled, the routine begins to process the next range by first computing y⁶⁴ (alternatively y¹²⁸) and by again filling in the look-up table 204 with any values that are used up to y¹²⁷ (alternatively y²⁵⁵). This continues until the exponent has been computed. As with the method described above, a routine has been implemented to determine the optimal initial look-up table size. The results of these simulations show that this method is successful in reducing the computation time when the CPU/co-processor ratio is less than 100 for 1024-bit exponentiation, and less than 160 for 2048-bit exponentiation.

In another embodiment of the present invention, an algorithm may be used that causes the CPU 102 to select a portion of the data string for processing that is larger than the present window size. For example, although the present window size k may be three, a five bit sub-string may be selected for processing. In such an example, if the 5 bit sub-string processed by the CPU 102 corresponds to a look-up table value that is larger than any value included in the look-up table 204, the CPU 102 can combine two or more values from the look-up table 204 to produce the look-up table value that corresponds to the five bit sub-string. This embodiment may be useful, for example, when the window sized sub-string corresponds to an even number, and only odd values are included in the look-up table 204. Alternatively, this method may be useful when each of the bits in the window sized sub-string is a zero. In this embodiment, the CPU 102 can quickly determine the bit length of the sub-string, and consequently, transfer to the co-processor 106 the number of squarings required. In order to save calculation time, the CPU may command the co-processor 106 to calculate the required number of squarings while the CPU 102 calculates the exponent.

Further, sub-strings leading zeroes may be simply counted, and not included in the computed sub-string. For example, if a bit string to be processed is 0001011001100, and k=4, then the first three zeroes are counted, set to a variable j=3, and removed from the bit-string. Therefore, the parsed sub-string would be 1011. The next two zeroes are counted, set to a variable j=2, and removed, such that the parsed sub-string would be 11. This process continues until the entire bit-string has been processed. The variable j is used to indicate to the co-processor the number of squarings to be performed before performing a modular multiplication with the passed CPU value (which is based on the number of leading zeroes and the number of bits in the parsed sub-string). In the above example, the passed CPU value is 7 and 4, and these values would be sent by the CPU to the co-processor.

The methods and examples described above focus primarily upon the implementation and subsequent modification of the sliding k-ary window method, however, the CPU/co-processor architecture described is equally applicable in elliptic curve cryptography multiplication using the sliding NAF k-ary window method. Any method that uses a pre-computation table to reduce the overall number of modular multiplications (modmuls) (or in the ECC the number of point multiplications performed), is applicable to the CPU/co-processor architecture described herein.

In the exponentiation methods described above, it is assumed that a single look-up table value transfer takes less time then a single modular squaring. This may not always be the case, however, because either the DMAC bus 110 or the CPU 102 may form a bottleneck during the look-up table data transfer. In such a case, the CPU 102 controls the co-processor's execution, but all of the look-up table values typically reside in the co-processor RAM 106a. This may be a severe limitation, because most efficient exponentiation methods rely upon pre-computed look-up tables. For example, suppose that a single look-up table transfer time is greater than the time it takes the co-processor 106 to compute approximately seven modular multiplications. Given a co-processor 106 with a RAM of 1.5 KB, if (1500*8)¹/log₂ (x)−2 is greater than 4, than the co-processor RAM 106a should be used to store the look-up table 204, and the sliding window method with a value of k=3 should be used. In such a situation, the look-up table 204 can be built using y and y², overwriting y² with the last look-up table value. If a look-up table 204 of size four can not be saved in the co-processor RAM 106a then one of two additional sub cases may apply, as described below.

In the first sub case, the CPU 102 is fast and the DMAC 108 is slow and forms the bottleneck. In this situation, the CPU 102 can be used to compute the inverse of y (y⁻¹), which is then transferred to the co-processor RAM 106a. The inverse of y can then be used in an optimal signed digit method (NAF recoding). The inverse of y may be computed, for example, using a modified greatest common divisor (GCD) algorithm as described, for example, in an article by M. A. Hasan entitled “Efficient Computation of Multiplicative Inverses for Cryptographic Applications.”

The second case is where the CPU 102 is slow and forms the bottleneck. In such a situation, the co-processor RAM 106a is used to store the look-up table 204. A size two look-up table 204 can be used, and the sliding window method with a value of k=2 is also used.

In another embodiment, the single look-up table value transfer time is less then the time it takes the co-processor 106 to compute approximately seven modular multiplications, but is greater then the time it takes the co-processor 106 to compute approximately one modular multiplication. If the CPU 102 is fast, and the DMAC 108 is the bottleneck, the situation is similar to the case where the CPU 102 helps build and store the look-up table 204, except that the initial pre-computation look-up table 204 will be smaller. The co-processor 106 will work with a window size of k=2 until the CPU 102 can build a look-up table 204 of an adequate size, or whenever the number of squarings to perform is greater then the transfer time. As such, the window size is variable.

If the CPU 102 is the bottleneck, the sliding k-ary window method may be the most efficient exponentiation method. In this case, the co-processor 106 builds the look-up table 204. The choice of the window size k depends upon both the size of log₂x (from y^{x}) and the transfer time. Suppose that t equals the transfer time, represented in co-processor modmul time units. For example, if it takes approximately 3 co-processor modmul time units before the transfer is complete, then t=3. The choice of the window size k can then be computed by the number of modular multiplications that are to be performed, and also includes the look-up table pre-computation costs (a high cost if the transfer time is long). For the sliding k-ary window method, the expected number of modular multiplications is approximately log₂(x)/k. The table cost is 2^{k-1}*t. A simple comparison of the window size k=3, 4, 5, 6 and 7 for appropriate values of x determines the optimal value for the window size k.

As indicated above, both the table size plus one method (y^{j+1}) and the table size plus two method (y^{j+2}) are successful in reducing exponentiation time in an encryption/decryption operation. Particularly, the table size plus one method is superior when the CPU/co-processor ratio is less than 100 for 1024-bit exponentiation, and less than 160 for 2048-bit exponentiation. Both the table size plus one method and table size plus two method provide substantial gains in execution time when the CPU/co-processor ratio is less than 100. In an alternative embodiment of the table size plus one method, the value y³² (y⁶⁴ for 2048-bit exponentiation) may be computed first, and the next window value that falls in the range of y³³ through y¹²⁷, as indicated by the exponent, may be calculated. In yet another embodiment, only the look-up table values that will be used two or more times during the exponentiation calculation are pre-computed.

Two additional examples of the present invention are presented below as Example 1 and Example 2. Example 1 illustrates a method by which CPU 102 determines which table value should be next sent to co-processor 106. Example 2 illustrates an exemplary method by which CPU 102 determines the next table value that CPU 102 should compute for co-processor 106.

### EXAMPLE 1

For this example, assume that e=111100011001011, and that k=3 for the computation of a^{e} mod p. In this example, the calculation is performed from right to left (i.e., most significant to least significant bit) (Note that the most significant bit may be on the left or the right; in this example, it is on the right). In this example, the LSB (least-significant bit) is one and starts the process by loading a into the buffer for processing (a is loaded into the co-processor buffer). Further, assume that a small table of exponentiation values has already been pre-processed. Further still, in this example, the sliding window method works by finding the largest odd valued string of bits that is less than 2^{k}. Zeroes (i.e., zeros) are skipped and simply mean the current exponentiation value is to be squared. In this example, all calculations are performed modulo p.

As such, in Example 1, a^{e} is calculated using the following five steps:

1) Co-processor 106 loads a into its computation buffer.

2) The next largest odd window value is 101. There are no leading zeros. So a⁵ is sent to co-processor 106 along with the value three. The co-processor 106 then performs three squaring operations followed by a multiplication by a⁵ (This computation is: a*a=a², then a²*a²=a⁴, then a⁴*a⁴=a⁸, then a⁸*a⁵=a¹³).

3) The next largest odd window value is 11 with two leading zeros. a³ is sent to co-processor 106 along with a value indicating that four squaring operations are to be performed (a¹³*a¹³=a²⁶, (a²⁶)²=a⁵², (a⁵²)²=a¹⁰⁴, (a¹⁰⁴)²=a²⁰⁸, a²⁰⁸*a³=a²¹¹).

4) The remaining portion of the bit string to be processed is 0001111. The largest odd window is 111, since k=3, with three preceding zeros. The CPU sends a⁷ and the value six for six squaring operations. (a²¹¹)²=a⁴²². (a⁴²²)²=a⁸⁴⁴. (a⁸⁴⁴)²=a¹⁶⁸⁸. (a¹⁶⁸⁸)²=a³³⁷⁶. (a³³⁷⁶)²=a⁶⁷⁵². (a⁶⁷⁵²)²=a¹³⁵⁰⁴. Then, a¹³⁵⁰⁴*a⁷=a¹³⁵¹¹.

5) Finally, one bit is left to be processed. So a and the value one for one squaring is sent. (a¹³⁵¹¹)²=a²⁷⁰²²*a=a²⁷⁰²³.

### EXAMPLE 2

For Example 2, assume e=0111010100111010000101000000110110111000011000010011, k=3, and the CPU/co-processor ratio is 10. In this example, it is desirable to look ahead to see which table value should be processed next by the CPU. This involves tracking the number of modular squarings and modular multiplications that will be performed by co-processor 106.

As such, this process is carried out using the following fifteen steps

1) The leading bit is discarded and a is sent and loaded into the coprocessor's buffer.

2) The next largest odd valued window size is one. As such, a is sent and the value one for one squaring. Running total is 1 squaring+1 multiplication=2 (roughly, modular multiplications are slightly slower than squarings).

3) Since 2<10, there is no time to compute another table value. Therefore, the next k sized window value is sent, which is one with two leading zeros. So a is again sent and the running total becomes 3 squarings+1 multiplication+2 from before=6.

4) 0000 is next so there are four squarings to be performed, so 4+6=10. At this point the CPU will have added a^{2\hat{ }k} (computes a^{2\hat{ }k-1}*a, a^{2\hat{ }k-1} exists in the current lookup table) to the lookup table where k=3. Now the process of checking which table value to add next to the lookup table may be started.

5) So a³ (11 window value) plus four leading zeros means 6 squarings+1 modmul+6=13. Since a^{2\hat{ }k} was computed first, this computation will be finished with 13−10=3 time units left over.

6) The next window value is a⁷ (111) with four leading zeros. So 7 squarings+1+3=11.

7) At this point the remaining bit string to be processed is 0111010100111010000101000000110110. Next a value/window of k=4 size that the CPU can compute for use later on by the co-processor chip is located. The value 1011 is size four and can be computed in time by the CPU before the co-processor chip needs that value. The CPU computes this value by multiplying a^{2\hat{ }3} (from above) with a⁵ to get a¹³. So when the co-processor is ready a¹³ is available and therefore the CPU can send a¹³ (1011) with one leading zero so 5 squarings+1+(11−10)=7.

8) Because 7<10, the process of looking ahead for the next value to add to the table is not ready to be commenced.

9) The next value to be processed is 1. 1+1+7=9.

10) As such, there are six zeros, so 6+9=15. Now, the process of looking ahead for another table value to add may be commenced. The first possibility, 101, is already in the table. Next is 1101, a¹¹. This is the next value the CPU will add to the table by computing a⁸*a³.

11) Returning to the main computation, the CPU sends a⁵ (101) with six leading zeros so that the co-processor will compute 9 squarings+1+9=19. Since a computation is in progress, 19−10 or 9 time units are left over.

12) The string left to process is 0111010100111010000. There are four zeros to be processed. 4+9>10 so there is time to compute another table value. Looking ahead, 1101 is already being worked upon. The next candidate is 1001. So once the CPU is finished computing a¹¹ it computes a⁹.

13) So a¹¹ will is along with the value eight (eight squarings, four leading zeros). 8+1+9=18. Because a⁹ is to be used next, 18−10=8 time units left over.

14) Next a⁹ is sent, there are no leading zeroes, so four squarings. 4+1+8=13.

15) The string left to process is 0111010. Looking ahead, 1101 already exists in the table. Therefore, the process of using the CPU to add to the table is completed, and now the exponentiation will be completed as normal.

Relating to Example 2, there are some timing issues. For example, to resolve timing issues, the number of squarings to be performed next may be sent to the co-processor chip first. While the co-processor chip is performing the modular squarings the next value for modular multiplication is sent. Since the transmission time is typically shorter than a single squaring, the value for modular multiplication will typically arrive before the co-processor chip needs it.

Although the present invention has been described in terms of hardware and software, it is contemplated that the invention could be implemented entirely in software on a computer readable carrier such as a magnetic or optical storage medium, or an auto frequency carrier or a radio frequency carrier. In this alternative embodiment, the multi-precision multiplication operation may be a separate thread running on the same processor in a single processor system or on a separate processor in a multi-processor system.

Although illustrated and described above with reference to certain specific embodiments, the present invention is nevertheless not intended to be limited to the details shown. Rather, various modifications may be made in the details within the scope and range of equivalence of the claims and without departing from the invention.

What is claimed:

1. A method for raising a base value to an exponent power as a part of an encryption/decryption operation using a computer architecture including a central processing unit and a co-processor independent of the central processing unit, the exponent power represented by a data string, the method comprising the steps of:
generating a look-up table indexed by a set of predetermined values, each value representing the base raised to a respectively different exponential power;
calculating, in the co-processor, the base value raised to the exponent power including the step of retrieving a sequence of the predetermined values from the look-up table according to a predetermined exponential algorithm, each of the predetermined values corresponding to one of a plurality of substrings of the data string; and
generating, using the central processing unit, additional predetermined values in the look-up table concurrently with the step of calculating.

2. The method of claim 1 wherein the sequence of the predetermined values are retrieved from the look-up table according to a sliding k-ary window method.

3. The method of claim 1 wherein the sequence of the predetermined values are retrieved from the look-up table according to a sliding non-adjacent form k-ary window method.

4. The method of claim 1 wherein a number of modular squarings that the co-processor can perform while the central processing unit computes a single modular multiplication is greater than one.

5. The method of claim 1 wherein the lookup table is generated by the co-processor and stored in random access memory connected to the central processing unit.

6. The method of claim 1 wherein the co-processor can compute multi-precision arithmetic faster than the central processing unit.

7. The method of claim 1 wherein the central processing unit controls the co-processor via a DMAC bus.

8. The method of claim 1 wherein the lookup table is stored in random access memory of the co-processor.

9. The method of claim 1 wherein the step of generating a look-up table includes generating the table such that a largest of the predetermined values represents the base value raised to the j power, j being an odd integer value, and the step of generating additional predetermined values includes generating one of the additional predetermined values that represents the base raised to the j+2 power.

10. The method of claim 1 wherein the step of generating a look-up table includes generating the table such that a largest of the predetermined values represents the base value raised to the j power, where j equals 2^{k-1}, and the step of generating additional predetermined values includes generating one of the additional predetermined values that represents the base raised to the j+1 power, where j+1 equals 2ⁿ.

11. The method of claim 1 wherein the step of generating additional predetermined values includes generating an additional predetermined value that corresponds to a substring of the data string not within a range of substrings referenced in the look-up table.

12. The method of claim 1 wherein the plurality of substrings have a window size of k bits, and the central processing unit selects, according to the predetermined exponential algorithm, a substring of the data string having a window size larger than k bits, and retrieves at least two values from the look-up table to be used by the central processing unit to generate an additional look-up table value that corresponds to the substring having a window size larger than k bits, the additional look-up table value to be used in the step of calculating.

13. A method for raising a base value to an exponent power as a part of an encryption/decryption operation using a computer architecture including a central processing unit and a co-processor independent of the central processing unit, the exponent power represented by a data string, the method comprising the steps of:
calculating, in the co-processor, using a sliding window method, the base value raised to the exponent power including the step of dividing said data string into a plurality of substrings; and
sending values, corresponding to each of the substrings, to said co-processor, from a look-up table, using the central processing unit.

14. The method of claim 13 further comprising the step of:
building the look-up table based on a predefined characteristic of said data string.

15. A computer readable medium including computer program instructions which cause a computer to implement a method for raising a base value to an exponent power as a part of an encryption/decryption operation using a computer architecture including a central processing unit and a co-processor independent of the central processing unit, the exponent power represented by a data string, the method comprising the steps of:
generating a look-up table indexed by a set of predetermined values, each value representing the base raised to a respectively different exponential power;
calculating, in the co-processor, the base value raised to the exponent power including the step of retrieving a sequence of the predetermined values from the look-up table according to a predetermined exponential algorithm, each of the predetermined values corresponding to one of a plurality of substrings of the data string; and
generating, using the central processing unit, additional predetermined values in the look-up table concurrently with the step of calculating.

16. An encryption/decryption system comprising;
a central processing unit;
a co-processor independent of the central processing unit; and
a computer readable medium including computer program instructions which cause a computer to implement a method for raising a base value to an exponent power, the exponent power represented by a data string, the method comprising the steps of:
generating a look-up table indexed by a set of predetermined values, each value representing the base raised to a respectively different exponential power;
calculating, in the co-processor, the base value raised to the exponent power including the step of retrieving a sequence of the predetermined values from the look-up table according to a predetermined exponential algorithm, each of the predetermined values corresponding to one of a plurality of substrings of the data string; and
generating, using the central processing unit, additional predetermined values in the look-up table concurrently with the step of calculating.

17. An apparatus for raising a base value to an exponent power as a part of an encryption/decryption operation using a computer architecture including a central processing unit and a co-processor independent of the central processing unit, the exponent power represented by a data string, the apparatus comprising:
means for generating a look-up table indexed by a set of predetermined values, each value representing the base raised to a respectively different exponential power;
means for calculating, in the co-processor, the base value raised to the exponent power including means for retrieving a sequence of the predetermined values from the look-up table according to a predetermined exponential algorithm, each of the predetermined values corresponding to one of a plurality of substrings of the data string; and
means for generating, using the central processing unit, additional predetermined values in the look-up table while the means for calculating calculates the base value raised to the exponent power.
